(19) United States
(12) Patent Application Publication
(10) Pub. No.: US 2018/0145736 A1
(43) Pub. Date: May 24, 2018

(54) Method for Transmitting Channel State Information and Transmission Device

(71) Applicant: Huawei Technologies Co., Ltd., Shenzhen (CN)

(72) Inventors: Xiaocui Li, Beijing (CN); Kai Xu, Beijing (CN)

(21) Appl. No.: 15/736,468

(22) PCT Filed: Jun. 30, 2015
(86) PCT No.: PCT/CN2015/082895

§ 371 Date: Dec. 14, 2017

(51) Int. Cl. H04B 7/06; H04W 72/04; H04W 24/10

(52) U.S. Cl. CPC H04B 7/0626; H04W 16/14; H04W 24/10; H04W 72/0413

(57) ABSTRACT

A method for transmitting channel state information and a transmission device includes sending, by a first device, carrier indication information to a second device, where the carrier indication information is used to indicate a carrier resource used when the second device sends channel state information of an unlicensed carrier; and receiving, by the first device, the channel state information sent by the second device. The first device indicates the carrier resource used for transmitting the channel state information, so that the second device can send the channel state information of the unlicensed carrier to the first device in time, and the first device can make a corresponding scheduling decision in time according to the channel state information of the unlicensed carrier.

### CROSS-REFERENCE TO RELATED APPLICATIONS

This application is a national stage of International Application No. PCT/CN2015/082895, filed on Jun. 30, 2015, which is hereby incorporated by reference in its entirety.

### TECHNICAL FIELD

The present disclosure relates to the communications field, and more specifically, to a method for transmitting channel state information and a device.

### BACKGROUND

In a licensed-assisted access using Long Term Evolution (LAA-LTE) system, a node uses a channel resource by using a listen before talk (LBT) principle. LBT is a carrier sense multiple access (CSMA) technology.

One main feature of a Long Term Evolution (LTE) system is that downlink transmission configuration and selection of a related parameter depend on an instantaneous channel condition of a downlink. Channel state information provided by a terminal for a network is an important factor for supporting related scheduling of a downlink channel, and the network needs to make a scheduling decision based on the channel state information.

There are two types of LTE channel state information, that is, periodic channel state information and aperiodic channel state information. A difference between the two types lies in how a report is triggered.

An aperiodic report is sent when the network performs a direct request by using a “channel state request” identifier included in an uplink scheduling grant. Aperiodic channel state information is always sent on a physical uplink shared channel (PUSCH), that is, a resource that is dynamically allocated.

Periodic channel state information configured by the network is sent in a specific period, and is usually sent on a physical uplink control channel (PPUCCH) resource.

In the LAA-LTE system, user equipment (UE) cannot always occupy a channel resource, and therefore, it is possible that the UE cannot report channel state information to a base station in time. Consequently, the base station cannot make a corresponding scheduling decision according to the channel state information.

### SUMMARY

Embodiments of the present disclosure provide a method for transmitting channel state information and a device, so that a scheduling side device can make a corresponding scheduling decision in time according to channel state information of an unlicensed carrier.

According to a first aspect, a method for transmitting channel state information is provided, including sending, by a first device, carrier indication information to a second device, where the carrier indication information is used to indicate a carrier resource used when the second device sends channel state information of an unlicensed carrier; and when the carrier resource indicated by the carrier indication information is a licensed carrier, receiving, on the licensed carrier by the first device, the channel state information sent by the second device.

With reference to the first aspect, in a first possible implementation, the carrier indication information is represented by an information bit; or the carrier indication information is represented by an information bit; or the carrier indication information is represented by a sequence number of a subcarrier used for transmitting designated signaling.

With reference to the first aspect or the first possible implementation of the first aspect, in a second possible implementation, a specific implementation of the sending, by a first device, carrier indication information to a second device is sending, by the first device, the carrier indication information to the second device by using downlink control information (DCI), where the DCI carries a channel state information (CSI) request and the carrier indication information, the CSI request is used to request the second device to send the channel state information of the unlicensed carrier, the first device is a base station, and the second device is user equipment.

With reference to the second possible implementation of the first aspect, in a third possible implementation, a specific implementation is: The carrier indication information is represented by a newly-added bit indicator in the DCI; or the carrier indication information is represented by an unused bit indicator in the DCI; or the carrier indication information is represented by bit information that does not have an indication meaning in the DCI.

According to a second aspect, a method for transmitting channel state information is provided, including receiving, by a second device, carrier indication information sent by a first device, where the carrier indication information is used to indicate a carrier resource used when the second device sends channel state information of an unlicensed carrier; and when the carrier resource indicated by the carrier indication information is a licensed carrier, sending, by the second device, the channel state information of the unlicensed carrier on the licensed carrier.

With reference to the second aspect, in a first possible implementation, a specific implementation is: The carrier indication information is represented by an information bit; or the carrier indication information is represented by a scrambling manner used for transmitting designated signaling; or the carrier indication information is represented by a sequence number of a subcarrier used for transmitting designated signaling.

With reference to the second aspect or the first possible implementation of the second aspect, in a second possible implementation, a specific implementation of the receiving, by a second device, carrier indication information sent by a first device is: receiving, by the second device, DCI to obtain the carrier indication information, where the DCI carries a channel state information CSI request and the carrier indication information, the CSI request is used to request the second device to send the channel state information of the unlicensed carrier, the first device is a base station, and the second device is user equipment; and a specific implementation of the sending, by the second device, the channel state information of the unlicensed carrier on the licensed carrier includes sending, by the second device, the channel state information of the unlicensed carrier on the licensed carrier according to the CSI request.

With reference to the second possible implementation of the second aspect, in a third possible implementation, a specific implementation is: The carrier indication information is represented by a newly-added bit indicator in the DCI; or the carrier indication information is represented by an unused bit indicator in the DCI; or the carrier indication information is represented by bit information that does not have an indication meaning in the DCI.

According to a third aspect, a method for transmitting channel state information is provided, including receiving, on a licensed carrier by a first device, channel state information sent by a second device, where the second device does not obtain a carrier resource of the unlicensed carrier at present, the channel state information carries an identifier of the unlicensed carrier, the first device is a base station, and the second device is user equipment; and determining, by the first device according to the identifier, that the channel state information is channel state information of the unlicensed carrier.

According to a fourth aspect, a method for transmitting channel state information is provided, including generating, by a second device, channel state information of an unlicensed carrier, where the channel state information carries an identifier of the unlicensed carrier, the second device does not obtain a carrier resource of the unlicensed carrier, the first device is a base station, and the second device is user equipment; and sending, by the second device, the channel state information on a licensed carrier.

According to a fifth aspect, a transmission device is provided, including a sending unit configured to send carrier indication information to a second device, where the carrier indication information is used to indicate a carrier resource used when the second device sends channel state information of an unlicensed carrier; and a receiving unit configured to: when the carrier resource indicated by the carrier indication information is a licensed carrier, receive, on the licensed carrier, the channel state information sent by the second device.

With reference to the fifth aspect, in a first possible implementation, a specific implementation is: The carrier indication information is represented by an information bit; or the carrier indication information is represented by a scrambling manner used for transmitting designated signaling; or the carrier indication information is represented by a sequence number of a subcarrier used for transmitting designated signaling.

With reference to the fifth aspect or the first possible implementation of the fifth aspect, in a second possible implementation, the sending unit is configured to send the carrier indication information to the second device by using DCI, where the DCI carries a channel state information CSI request and the carrier indication information, the CSI request is used to request the second device to send the channel state information of the unlicensed carrier, the transmission device is a base station, and the second device is user equipment.

With reference to the second possible implementation of the fifth aspect, in a third possible implementation, a specific implementation is: The carrier indication information is represented by a newly-added bit indicator in the DCI; or the carrier indication information is represented by an unused bit indicator in the DCI; or the carrier indication information is represented by bit information that does not have an indication meaning in the DCI.

According to a sixth aspect, a transmission device is provided, including a receiving unit configured to receive carrier indication information sent by a first device, where the carrier indication information is used to indicate a carrier resource used when the transmission device sends channel state information of an unlicensed carrier; and a sending unit configured to: when the carrier resource indicated by the carrier indication information is a licensed carrier, send the channel state information of the unlicensed carrier on the licensed carrier.

With reference to the sixth aspect, in a first possible implementation, a specific implementation is: The carrier indication information is represented by an information bit; or the carrier indication information is represented by a scrambling manner used for transmitting designated signaling; or the carrier indication information is represented by a sequence number of a subcarrier used for transmitting designated signaling.

With reference to the sixth aspect or the first possible implementation of the sixth aspect, the receiving unit is configured to receive DCI to obtain the carrier indication information, where the DCI carries a channel state information CSI request and the carrier indication information, the CSI request is used to request the transmission device to send the channel state information of the unlicensed carrier, the first device is a base station, and the transmission device is user equipment; and the sending unit is configured to send the channel state information of the unlicensed carrier on the licensed carrier according to the CSI request.

With reference to the second possible implementation of the sixth aspect, in a third possible implementation, a specific implementation is: The carrier indication information is represented by a newly-added bit indicator in the DCI; or the carrier indication information is represented by an unused bit indicator in the DCI; or the carrier indication information is represented by bit information that does not have an indication meaning in the DCI.

With reference to the sixth aspect, in a fourth possible implementation, a specific implementation is: The carrier indication information is represented in an implicit manner.

With reference to any possible implementation of the sixth aspect, the first possible implementation of the sixth aspect, the second possible implementation of the sixth aspect, or the fourth possible implementation of sixth aspect, in a fifth possible implementation, the sending unit is configured to send, in a first channel state information period after a moment at which the carrier indication information is received, the channel state information of the user equipment on the carrier resource indicated by the carrier indication information, where the user equipment reports the channel state information in a periodic reporting manner, and in the LAA-LTE system, the base station preempts a channel resource in an LBT manner before uplink transmission.

According to a seventh aspect, a transmission device is provided, including a receiving unit configured to receive, on a licensed carrier, channel state information sent by a second device, where the second device does not obtain a carrier resource of an unlicensed carrier at present, the channel state information carries an identifier of the unlicensed carrier, the transmission device is a base station, and the second device is user equipment; and a determining unit configured to determine, according to the identifier, that the channel state information is channel state information of the unlicensed carrier.

According to an eighth aspect, a transmission device is provided, including a generation unit configured to generate channel state information of an unlicensed carrier, where the channel state information carries an identifier of the unlicensed carrier, the transmission device does not obtain a carrier resource of the unlicensed carrier at present, the first device is a base station, and the transmission device is user equipment; and a sending unit configured to send the channel state information on a licensed carrier.

According to the method for transmitting channel state information and the device in the embodiments of the present disclosure, the first device indicates, to the second device, the carrier resource used for transmitting the channel state information, so that the second device can send the channel state information of the unlicensed carrier to the first device in time, and the first device can make a corresponding scheduling decision in time according to the channel state information of the unlicensed carrier.

### BRIEF DESCRIPTION OF DRAWINGS

To describe the technical solutions in the embodiments of the present disclosure more clearly, the following briefly describes the accompanying drawings for describing the embodiments or some approaches. The accompanying drawings in the following description show some embodiments of the present disclosure, and a person of ordinary skill in the art may still derive other drawings from these accompanying drawings without creative efforts.

FIG. 1 is a flowchart of a method for transmitting channel state information according to an embodiment of the present disclosure;

FIG. 2 is a flowchart of interaction of transmitting channel state information according to an embodiment of the present disclosure;

FIG. 3 is a flowchart of another method for transmitting channel state information according to an embodiment of the present disclosure;

FIG. 4 is a flowchart of still another method for transmitting channel state information according to an embodiment of the present disclosure;

FIG. 5 is a flowchart of still another method for transmitting channel state information according to an embodiment of the present disclosure;

FIG. 6 is a schematic structural diagram of a transmission device according to an embodiment of the present disclosure;

FIG. 7 is a schematic structural diagram of another transmission device according to an embodiment of the present disclosure;

FIG. 8 is a schematic structural diagram of still another transmission device according to an embodiment of the present disclosure;

FIG. 9 is a schematic structural diagram of still another transmission device according to an embodiment of the present disclosure;

FIG. 10 is a schematic structural diagram of still another transmission device according to an embodiment of the present disclosure;

FIG. 11 is a schematic structural diagram of still another transmission device according to an embodiment of the present disclosure;

FIG. 12 is a schematic structural diagram of still another transmission device according to an embodiment of the present disclosure; and

FIG. 13 is a schematic structural diagram of still another transmission device according to an embodiment of the present disclosure.

### DESCRIPTION OF EMBODIMENTS

The following clearly and completely describes the technical solutions in the embodiments of the present disclosure with reference to the accompanying drawings in the embodiments of the present disclosure. The described embodiments are some but not all of the embodiments of the present disclosure. All other embodiments obtained by a person of ordinary skill in the art based on the embodiments of the present disclosure without creative efforts shall fall within the protection scope of the present disclosure.

The technical solutions of the present disclosure may be applied to various communications systems, such as: a Global System for Mobile Communications (GSM), a Code Division Multiple Access (CDMA) system, a Wideband Code Division Multiple Access (WCDMA), a general packet radio service (GPRS), and LTE.

User equipment (UE), also referred to as a mobile terminal, mobile user equipment, and the like, may communicate with one or more core networks over a radio access network (RAN). The user equipment may be a mobile terminal, such as a mobile phone (also referred to as a “cellular” phone) and a computer with a mobile terminal. For example, the user equipment may be a portable, pocket-sized, handheld, computer built-in, or in-vehicle mobile apparatus, which exchanges voice and/or data with the radio access network.

A base station may be a base transceiver station (BTS) in GSM or CDMA, or may be a NodeB in WCDMA, or may be an evolved NodeB (eNB or e-NodeB, evolutional Node B) in LTE, and this is not limited in the present disclosure. However, for ease of description, the following embodiments are described by using an eNB as an example.

Spectrums used in a wireless communications system include a licensed spectrum and an unlicensed spectrum. The licensed spectrum can be used only after a grant is obtained, and the unlicensed spectrum can be legally used by anyone without needing a grant. A carrier on the licensed spectrum is referred to as a licensed carrier, and a carrier on the unlicensed spectrum is referred to as an unlicensed carrier. A wireless communications system in which communication is performed by using both a licensed spectrum and an unlicensed spectrum and that includes but is not limited to an LAA-LTE system is applicable to an application scenario of a method and a device in the embodiments of the present disclosure.

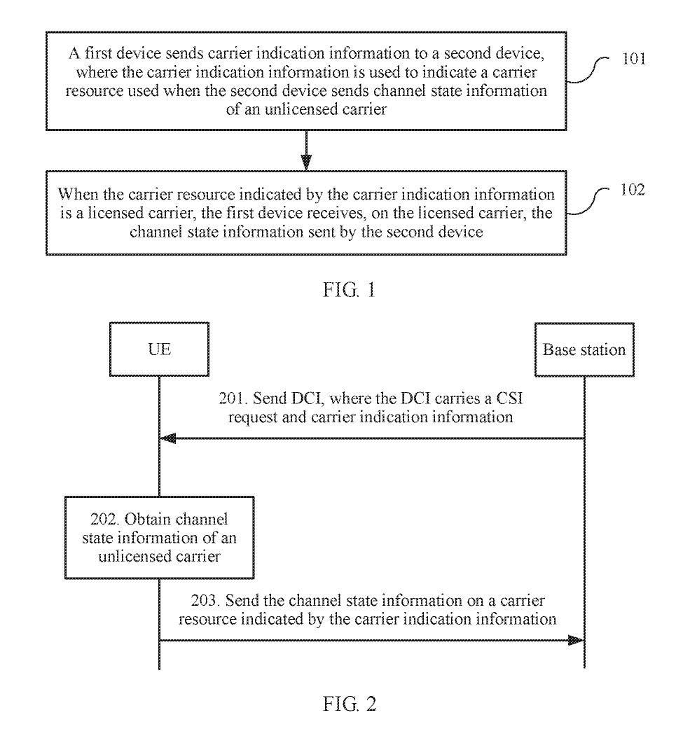

FIG. 1 is a flowchart of a method for transmitting channel state information according to an embodiment of the present disclosure. The method includes the following steps.

101. A first device sends carrier indication information to a second device.

The carrier indication information is used to indicate a carrier resource used when the second device sends channel state information of an unlicensed carrier.

It should be noted that the first device and the second device can perform communication by using a licensed carrier and an unlicensed carrier. For example, in an LAA system, when there is an unlicensed carrier resource, a base station and UE perform communication by using the unlicensed carrier; and when there is no unlicensed carrier resource, the base station and the UE perform communication by using a licensed carrier.

102. When a carrier resource indicated by the carrier indication information is a licensed carrier, the first device receives, on the licensed carrier, the channel state information sent by the second device.

In this embodiment of the present disclosure, the first device indicates, to the second device, the carrier resource used for transmitting the channel state information, so that the second device can send the channel state information of the unlicensed carrier to the first device in time, and the first device can make a corresponding scheduling decision in time according to the channel state information of the unlicensed carrier.

Optionally, the carrier indication information is represented by an information bit; or the carrier indication information is represented by a scrambling manner used for transmitting designated signaling; or the carrier indication information is represented by a sequence number of a subcarrier used for transmitting designated signaling.

Optionally, in an embodiment, a specific implementation of step 101 is the first device sends the carrier indication information to the second device by using DCI. The DCI carries a channel state information CSI request and the carrier indication information, the CSI request is used to request the second device to send the channel state information of the unlicensed carrier, the first device is a base station, and the second device is user equipment.

Further, the carrier indication information is represented by a newly-added bit indicator in the DCI.

Alternatively, further, the carrier indication information is represented by an unused bit indicator in the DCI.

Alternatively, further, the carrier indication information is represented by bit information that does not have an indication meaning in the DCI.

FIG. 2 is a flowchart of interaction of transmitting channel state information in an LAA system according to an embodiment of the present disclosure. In FIG. 2, a first device is a base station, and a second device is UE. The UE sends channel state information of an unlicensed carrier to the base station in an aperiodic manner. It should be understood that the first device mentioned in any part of the present disclosure is a device receiving channel state information of an unlicensed carrier; and the second device mentioned in any part of the present disclosure is a device sending channel state information of an unlicensed carrier.

201. The base station sends DCI to the UE, where the DCI carries a CSI request and carrier indication information.

For an aperiodic report, the DCI includes a 2-bit CSI request. Therefore, when there is the CSI request, whether the UE transmits aperiodic channel state information on an unlicensed carrier or a licensed carrier may be centrally configured by a base station side. Generally, the channel state information may be represented by a channel state information report (CSI Report).

TABLE 1

| Value of a CSI | |
|---|---|
| request field | Description |
| 00 | No aperiodic CSI report is triggered |
| 01 | Aperiodic CSI report is triggered for serving cell c |
| 10 | Aperiodic CSI report is triggered for a 1st set of serving |
| | cells configured by higher layers |
| 11 | Aperiodic CSI report is triggered for a 2nd set of serving |
| | cells configured by higher layers |

Table 1 is a schematic diagram of a value of the CSI request field. As shown in Table 1, when a Value of CSI request field is “01”, “10”, or “11”, there is an aperiodic channel state information request.

When the channel state information is reported in the aperiodic manner, the base station needs to send the CSI request to the UE. The CSI request is used to request the UE to report the channel state information of the unlicensed carrier.

The base station may send the DCI to the UE, and may add the CSI request to the DCI.

In addition, the base station may further send the carrier indication information to the UE, so as to indicate a carrier resource used when the UE sends the channel state information of the unlicensed carrier.

There are two main manners for LAA uplink transmission. One is that the base station preempts a channel resource (an unlicensed carrier resource) in an LBT manner, that is, the eNB performs LBT before UL transmission, and if the base station obtains the channel resource by means of preemption, the base station sends a UL grand to the UE, and occupies the channel so that the UE performs UL transmission. The other is that the UE preempts a carrier resource in the LBT manner, that is, the UE performs LBT before UL transmission; after receiving a UL grand, the UE preempts a channel in the LBT manner, and if the channel is idle, the UE obtains the channel by means of preemption, and the UE sends data according to scheduling by the eNB. In either manner, the base station may know whether the channel resource is obtained by means of preemption.

When the channel resource is obtained by means of preemption (regardless of whether the channel resource is obtained by the base station or the UE by means of preemption), the base station may instruct, by using the carrier indication information, the UE to send the channel state information by using the unlicensed carrier; and when the channel resource is not obtained by means of preemption, the base station may instruct, by using the carrier indication information, the UE to send the channel state information by using a licensed carrier.

The base station may explicitly or implicitly send the carrier indication information. In this case, the carrier indication information is represented by an information bit.

Optionally, the base station may use a newly-added bit indicator in the DCI to represent the carrier indication information. For example, the carrier indication information may be represented by a newly-added carrier bit indicator in a format 0 or a format 4 in the DCI. The base station may add a bit to the format 0 or the format 4 in the DCI, and may use the bit as a carrier bit indicator. For example, 0 is used to indicate that the CSI report is transmitted on the unlicensed carrier, and 1 is used to indicate that the CSI report is transmitted on a licensed carrier.

Optionally, the base station may use an unused bit indicator in the DCI to represent the carrier indication information. For example, the carrier indication information is represented by an unused bit in a format 0 or a format 4 in the DCI. The base station may find an unused bit from the format 0 or the format 4 in the DCI, and may use the bit as a carrier bit indicator.

Optionally, the base station may further use bit information that does not have a specific meaning in the DCI to represent the carrier indication information. For example, the carrier indication information is represented by two types of bit information that does not have an indication meaning in a format 0 or a format 4 in the DCI. The base station may find, from the format 0 or the format 4 in the DCI, two types of bit information that does not have an indication meaning, so as to indicate whether the channel state information is transmitted on the unlicensed carrier or the channel state information is transmitted on a licensed carrier. For example, a carrier indicator field (CIF) in the format 0 or the format 4 in the DCI includes 3 bits, and the carrier indicator field may indicate 8 numerical values: 0, 1, 2, 3, 4, 5, 6, and 7. However, when supporting multiple carriers, an existing system supports a maximum of five carriers. In this case, it means that 0, 1, 2, 3, and 4 are used, and the three values: 5, 6, and 7 do not have any specific meaning. In this case, 5 (101 in a binary system) may be used to indicate that the CSI report is transmitted on the unlicensed carrier, 6 (110 in the binary system) may be used to indicate that the CSI report is transmitted on a licensed carrier, and the like.

The base station may implicitly send the carrier indication information to the UE.

Optionally, the carrier indication information is represented by a scrambling manner used for transmitting designated signaling. For example, the base station and the UE may pre-agree on representing the carrier indication information by a scrambling manner used for transmitting the DCI. A scrambling manner 1 indicates that the channel state information is transmitted by using a licensed carrier, a scrambling manner 2 indicates that the channel state information is transmitted by using the unlicensed carrier, and the like. Certainly, the carrier indication information may also be represented by a scrambling manner specified by a protocol.

Optionally, the carrier indication information is represented by a sequence number of a subcarrier used for transmitting designated signaling. For example, when the base station sends the DCI on the 0^{th} to (N-1)^{th} subcarrier, it indicates that the channel state information is transmitted by using the unlicensed carrier; and when the base station sends the DCI on the N^{th} to (2N-1)^{th} subcarrier, it indicates that the channel state information is transmitted by using a licensed carrier. N is a positive integer.

202. The UE obtains channel state information of an unlicensed carrier.

The UE obtains the channel state information of the unlicensed carrier according to the CSI request carried in the DCI. Details are not described herein again in this embodiment of the present disclosure.

203. Send the channel state information on a carrier resource indicated by the carrier indication information.

When the carrier resource indicated by the carrier indication information is a licensed carrier, the UE sends the channel state information of the unlicensed carrier on the licensed carrier. In this case, the channel state information sent by the UE is transmitted in a cross-carrier manner.

When the carrier resource indicated by the carrier indication information is an unlicensed carrier, the UE sends the channel state information on the unlicensed carrier.

Optionally, in another embodiment, a specific implementation of step 101 is when the first device preempts a channel resource in an LBT manner, and the first device does not obtain the channel resource by means of preemption, the first device sends the carrier indication information to the second device. The carrier indication information is used to instruct the second device to transmit the channel state information of the unlicensed carrier on a licensed carrier, the first device is a base station, and the second device is user equipment.

For example, in an LAA system, the UE reports channel state information of an unlicensed carrier to the base station in a periodic manner, and the base station preempts a channel resource in the LBT manner before uplink transmission. When the base station does not obtain the channel resource by means of preemption, the base station may explicitly or implicitly send the carrier indication information, so as to instruct the UE to report the channel state information of the unlicensed carrier on a licensed carrier. For a specific implementation, refer to the embodiment shown in FIG. 2. Details are not described herein again in this embodiment of the present disclosure.

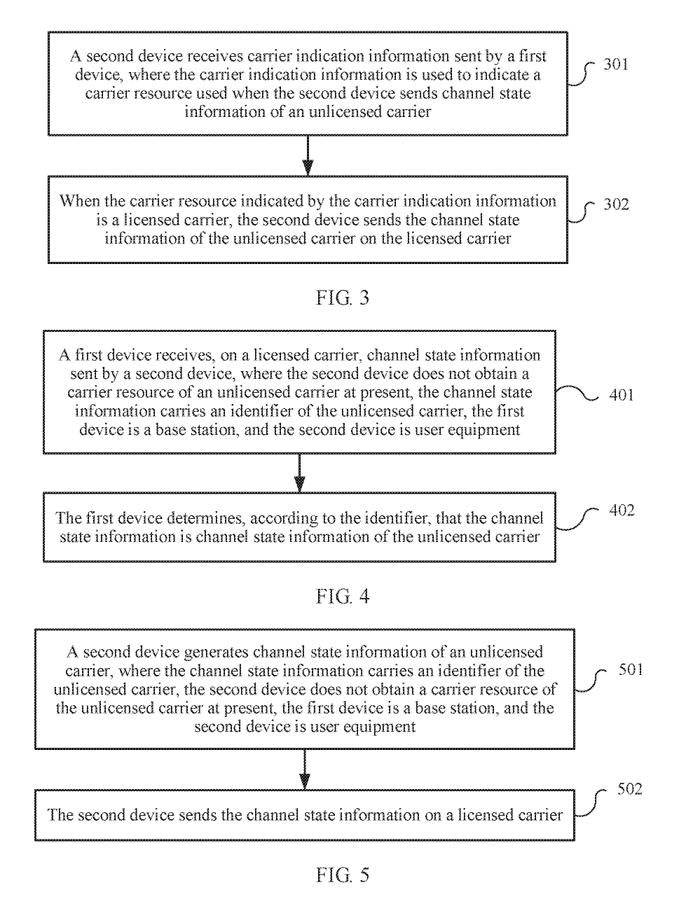

FIG. 3 is a flowchart of another method for transmitting channel state information according to an embodiment of the present disclosure. The method in FIG. 3 is executed by a second device, and the method includes the following steps.

301. The second device receives carrier indication information sent by a first device.

The carrier indication information is used to indicate a carrier resource used when the second device sends channel state information of an unlicensed carrier.

302. When a carrier resource indicated by the carrier indication information is a licensed carrier, the second device sends channel state information of an unlicensed carrier on the licensed carrier.

In this embodiment of the present disclosure, the second device reports the channel state information of the unlicensed carrier to the first device in time according to the carrier resource that is used for transmitting the channel state information and that is indicated by the first device, so that the first device can make a corresponding scheduling decision in time according to the channel state information of the unlicensed carrier.

Optionally, the carrier indication information is represented by an information bit; or the carrier indication information is represented by a scrambling manner used for transmitting designated signaling; or the carrier indication information is represented by a sequence number of a subcarrier used for transmitting designated signaling.

Optionally, in an embodiment, a specific implementation of step 301 is that the second device receives carrier indication information sent by a first device that includes the second device receives DCI to obtain the carrier indication information. The DCI carries a channel state information CSI request and the carrier indication information, the CSI request is used to request the second device to send the channel state information of the unlicensed carrier, the first device is a base station, and the second device is user equipment. A specific implementation of step 302 is the second device sends the channel state information of the unlicensed carrier on the licensed carrier according to the CSI request.

Further, the carrier indication information is represented by a newly-added bit indicator in the DCI; or the carrier indication information is represented by an unused bit indicator in the DCI; or the carrier indication information is represented by bit information that does not have an indication meaning in the DCI.

For a specific implementation of this embodiment, refer to the method implemented by UE in the embodiment shown in FIG. 2. Details are not described herein again in this embodiment of the present disclosure.

Optionally, in another embodiment, a specific implementation of step 302 is the second device sends the channel state information of the unlicensed carrier on the licensed carrier in a first channel state information period after a moment at which the carrier indication information is received.

For example, in an LAA system, the UE reports channel state information of an unlicensed carrier to the base station in a periodic manner, and the base station preempts a channel resource in an LBT manner before uplink transmission. When the base station does not obtain the channel resource by means of preemption, the base station may explicitly or implicitly send the carrier indication information, so as to instruct the UE to report the channel state information of the unlicensed carrier on a licensed carrier. For a specific implementation, refer to the embodiment shown in FIG. 2. Details are not described herein again in this embodiment of the present disclosure. After receiving the instruction, the UE may send the channel state information of the unlicensed carrier on the licensed carrier in a first channel state information period after the carrier indication information is received.

FIG. 4 is a flowchart of still another method for transmitting channel state information according to an embodiment of the present disclosure. The method in FIG. 4 is executed by a first device, and the method includes the following steps.

401. The first device receives, on a licensed carrier, channel state information sent by a second device.

The second device cannot use a carrier resource of an unlicensed carrier at present, the channel state information carries an identifier of the unlicensed carrier, the first device is a base station, and the second device is user equipment.

402. The first device determines, according to the identifier, that the channel state information is channel state information of the unlicensed carrier.

In this embodiment of the present disclosure, the first device determines, by using the carrier identifier in the channel state information sent by the second device on the licensed carrier, the unlicensed carrier to which the channel state information belongs, so that the first device can make a corresponding scheduling decision in time according to the channel state information of the unlicensed carrier.

A manner of periodically reporting the channel state information of the unlicensed carrier, or a manner of aperiodically reporting the channel state information of the unlicensed carrier is applicable to the method in this embodiment of the present disclosure.

For example, in the embodiment shown in FIG. 2, when reporting the channel state information, alternatively, the UE may add the identifier of the unlicensed carrier to the channel state information of the unlicensed carrier, and when receiving the channel state information on the licensed carrier, the base station may determine, according to the identifier in the channel state information, that the channel state information belongs to the unlicensed carrier.

For another example, in an LAA system, the UE preempts a channel resource of an unlicensed carrier in an LBT manner before uplink transmission, that is, the UE performs LBT before UL transmission. A first device is a base station, and a second device is UE. After receiving a UL grand, the UE preempts a channel in the LBT manner. If the channel is idle, the UE obtains the channel by means of preemption, and the UE sends data according to scheduling by the eNB. If the UE does not obtain the channel by means of preemption, the UE transmits periodic channel state information of an unlicensed carrier in a cross-carrier manner on a licensed carrier, and adds a carrier number of this carrier (the unlicensed carrier) when reporting the periodic channel state information on the licensed carrier. After receiving, on the licensed carrier, the channel state information sent by the UE, the base station may identify, according to the carrier number, a carrier to which the channel state information belongs.

FIG. 5 is a flowchart of still another method for transmitting channel state information according to an embodiment of the present disclosure. The method in FIG. 5 is executed by a second device, and the method includes the following steps.

501. The second device generates channel state information of an unlicensed carrier.

The channel state information carries an identifier of the unlicensed carrier, the second device does not obtain a carrier resource of the unlicensed carrier at present, the first device is a base station, and the second device is user equipment.

502. The second device sends the channel state information on a licensed carrier.

In this embodiment of the present disclosure, the second device adds the identifier of the unlicensed carrier to the channel state information of the unlicensed carrier, and then sends the channel state information to the first device on the licensed carrier, so that the first device can determine, according to the identifier, the unlicensed carrier to which the channel state information belongs, and the first device can make a corresponding scheduling decision in time according to the channel state information of the unlicensed carrier.

A manner of periodically reporting the channel state information of the unlicensed carrier, or a manner of aperiodically reporting the channel state information of the unlicensed carrier is applicable to the method in this embodiment of the present disclosure.

For example, in the embodiment shown in FIG. 2, when reporting the channel state information, alternatively, the UE may add the identifier of the unlicensed carrier to the channel state information of the unlicensed carrier, and when receiving the channel state information on the licensed carrier, the base station may determine, according to the identifier in the channel state information, that the channel state information belongs to the unlicensed carrier.

For another example, in an LAA system, the UE preempts a channel resource of an unlicensed carrier in an LBT manner before uplink transmission, that is, the UE performs LBT before UL transmission. A first device is a base station, and a second device is UE. After receiving a UL grand, the UE preempts a channel in the LBT manner. If the channel is idle, the UE obtains the channel by means of preemption, and the UE sends data according to scheduling by the eNB. If the UE does not obtain the channel by means of preemption, the UE transmits periodic channel state information of an unlicensed carrier in a cross-carrier manner on a licensed carrier, and adds a carrier number of this carrier (the unlicensed carrier) when reporting the periodic channel state information on the licensed carrier. After receiving, on the licensed carrier, the channel state information sent by the UE, the base station may identify, according to the carrier number, a carrier to which the channel state information belongs.

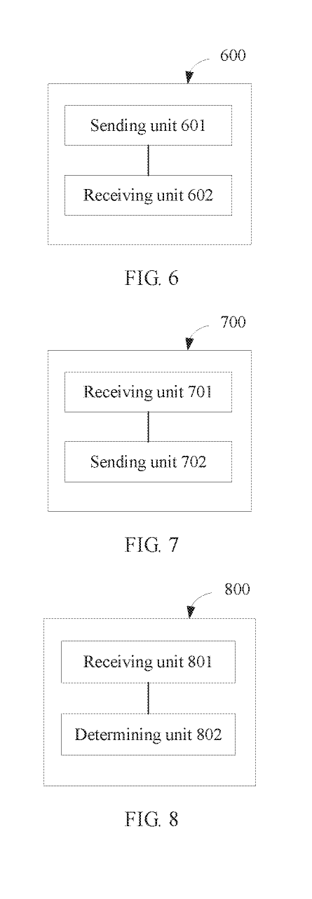

FIG. 6 is a schematic structural diagram of a transmission device 600 according to an embodiment of the present disclosure. The transmission device 600 includes a sending unit 601 and a receiving unit 602.

The sending unit 601 is configured to send carrier indication information to a second device.

The carrier indication information is used to indicate a carrier resource used when the second device sends channel state information of an unlicensed carrier.

The receiving unit 602 is configured to, when the carrier resource indicated by the carrier indication information is a licensed carrier, receive, on the licensed carrier, the channel state information sent by the second device.

In this embodiment of the present disclosure, the transmission device 600 indicates, to the second device, the carrier resource used for transmitting the channel state information, so that the second device can send the channel state information of the unlicensed carrier to the transmission device in time, and the transmission device 600 can make a corresponding scheduling decision in time according to the channel state information of the unlicensed carrier.

Optionally, the carrier indication information is represented by an information bit; or the carrier indication information is represented by a scrambling manner used for transmitting designated signaling; or the carrier indication information is represented by a sequence number of a subcarrier used for transmitting designated signaling.

Optionally, in an embodiment, the sending unit 601 is configured to send the carrier indication information to the second device by using DCI. The DCI carries a CSI request and the carrier indication information. The CSI request is used to request the second device to send the channel state information of the unlicensed carrier, the transmission device 600 is a base station, and the second device is user equipment.

Further, the carrier indication information is represented by a newly-added bit indicator in the DCI; or the carrier indication information is represented by an unused bit indicator in the DCI; or the carrier indication information is represented by bit information that does not have an indication meaning in the DCI.

Optionally, in another embodiment, the sending unit 601 is configured to, when the transmission device 600 preempts a channel resource in an LBT manner, and the transmission device 600 does not obtain the channel resource by means of preemption, send the carrier indication information to the second device. The carrier indication information is used to instruct the second device to transmit the channel state information of the unlicensed carrier on the licensed carrier, the transmission device 600 is a base station, and the second device is user equipment.

The transmission device 600 may further execute the method in FIG. 1 and may implement functions of the first device or the base station in the embodiments shown in FIG. 1 and FIG. 2. Details are not described herein again in this embodiment of the present disclosure.

FIG. 7 is a schematic structural diagram of a transmission device 700 according to an embodiment of the present disclosure. The transmission device 700 includes a receiving unit 701 and a sending unit 702.

The receiving unit 701 is configured to receive carrier indication information sent by a first device.

The carrier indication information is used to indicate a carrier resource used when the transmission device 700 sends channel state information of an unlicensed carrier.

The sending unit 702 is configured to, when the carrier resource indicated by the carrier indication information is a licensed carrier, send the channel state information of the unlicensed carrier on the licensed carrier.

In this embodiment of the present disclosure, the transmission device 700 reports the channel state information of the unlicensed carrier to the first device in time according to the carrier resource that is used for transmitting the channel state information and that is indicated by the first device, so that the first device can make a corresponding scheduling decision in time according to the channel state information of the unlicensed carrier.

Optionally, the carrier indication information is represented by an information bit; or the carrier indication information is represented by a scrambling manner used for transmitting designated signaling; or the carrier indication information is represented by a sequence number of a subcarrier used for transmitting designated signaling.

Optionally, in an embodiment, the receiving unit 701 is configured to receive DCI to obtain the carrier indication information. The DCI carries a channel state information CSI request and the carrier indication information, the CSI request is used to request the transmission device 700 to send the channel state information of the unlicensed carrier, the first device is a base station, and the transmission device 700 is user equipment. The sending unit 702 is configured to send the channel state information of the unlicensed carrier on the licensed carrier according to the CSI request.

Further, the carrier indication information is represented by a newly-added bit indicator in the DCI; or the carrier indication information is represented by an unused bit indicator in the DCI; or the carrier indication information is represented by bit information that does not have an indication meaning in the DCI.

Optionally, in another embodiment, the sending unit 702 is configured to send the channel state information of the unlicensed carrier on the licensed carrier in a first channel state information period after a moment at which the carrier indication information is received.

The transmission device 700 may further execute the method in FIG. 3 and may implement functions of the second device or the UE in the embodiments shown in FIG. 2 and FIG. 3. Details are not described herein again in this embodiment of the present disclosure.

FIG. 8 is a schematic structural diagram of a transmission device 800 according to an embodiment of the present disclosure. The transmission device 800 includes a receiving unit 801 and a determining unit 802.

The receiving unit 801 is configured to receive, on a licensed carrier, channel state information sent by a second device.

The second device does not obtain a carrier resource of an unlicensed carrier at present, the channel state information carries an identifier of the unlicensed carrier, the transmission device 800 is a base station, and the second device is user equipment.

The determining unit 802 is configured to determine, according to the identifier, that the channel state information is channel state information of the unlicensed carrier.

In this embodiment of the present disclosure, the transmission device 800 determines, by using the carrier identifier in the channel state information sent by the second device on the licensed carrier, the unlicensed carrier to which the channel state information belongs, so that the transmission device 800 can make a corresponding scheduling decision in time according to the channel state information of the unlicensed carrier.

The transmission device 800 may further execute the method in FIG. 4 and may implement functions of the first device or the base station in the embodiment shown in FIG. 4. Details are not described herein again in this embodiment of the present disclosure.

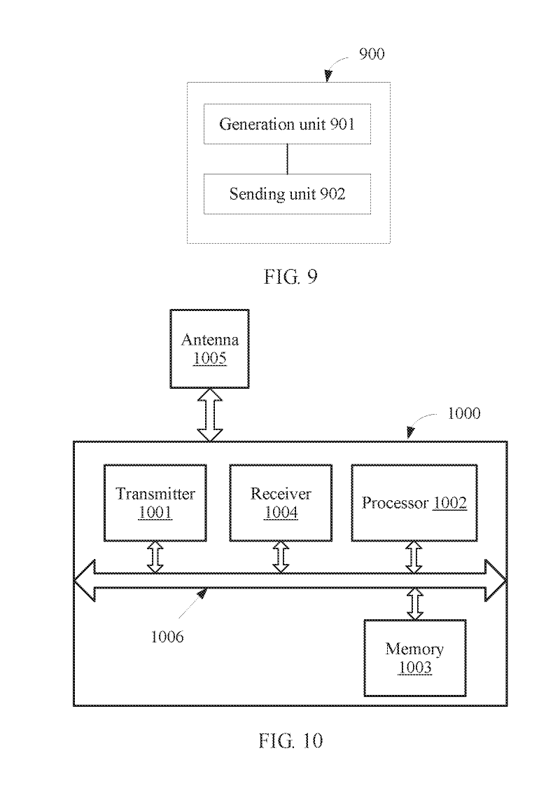

FIG. 9 is a schematic structural diagram of a transmission device 900 according to an embodiment of the present disclosure. The transmission device 900 includes a generation unit 901 and a sending unit 902.

The generation unit 901 is configured to generate channel state information of an unlicensed carrier.

The channel state information carries an identifier of the unlicensed carrier, the transmission device 900 does not obtain a carrier resource of the unlicensed carrier at present, the first device is a base station, and the transmission device 90 is user equipment.

The sending unit 902 is configured to send the channel state information on a licensed carrier.

In this embodiment of the present disclosure, the transmission device 900 adds the identifier of the unlicensed carrier to the channel state information of the unlicensed carrier, and then sends the channel state information to the first device on the licensed carrier, so that the first device can determine, according to the identifier, the unlicensed carrier to which the channel state information belongs, and the first device can make a corresponding scheduling decision in time according to the channel state information of the unlicensed carrier.

The transmission device 900 may further execute the method in FIG. 5 and may implement functions of the second device or the UE in the embodiment shown in FIG. 5. Details are not described herein again in this embodiment of the present disclosure.

FIG. 10 is a schematic structural diagram of a transmission device 1000 according to an embodiment of the present disclosure. The transmission device 1000 may include a processor 1002, a memory 1003, a transmitter 1001, and a receiver 1004. In specific application, the transmission device 1000 may be a base station, a relay, a radio access point (AP), or the like.

The receiver 1004, the transmitter 1001, the processor 1002, and the memory 1003 are connected to each other by using a bus system 1006. The bus 1006 may be an ISA bus, a PCI bus, an EISA bus, or the like. The bus may include an address bus, a data bus, a control bus, or the like. For ease of indication, in FIG. 10, the bus is indicated by using only one double-headed arrow; however, it does not mean that there is only one bus or only one type of bus. In specific application, the transmitter 1001 and the receiver 1004 may be coupled to an antenna 1005.

The memory 1003 is configured to store a program. The program may include program code, and the program code includes a computer operation instruction. The memory 1003 may include a read-only memory and a random access memory, and provide an instruction and data for the processor 1002. The memory 1003 may include a high-speed random access memory (RAM) memory, and may also include a non-volatile memory, for example at least one magnetic disk memory.

The processor 1002 executes the program stored by the memory 1003 and is configured to perform the following operations: sending carrier indication information to a second device by using the transmitter 1001, where the carrier indication information is used to indicate a carrier resource used when the second device sends channel state information of an unlicensed carrier; and when the carrier resource indicated by the carrier indication information is a licensed carrier, receiving, on the licensed carrier by using the receiver 1004, the channel state information sent by the second device.

The foregoing method that is executed by the first device or the base station and that is disclosed in either of the embodiments in FIG. 1 and FIG. 2 of the present disclosure may be applied to the processor 1002, or may be implemented by the processor 1002. The processor 1002 may be an integrated circuit chip and has a signal processing capability. In an implementation process, steps in the foregoing methods may be completed by means of an integrated logic circuit of hardware in the processor 1002 or an instruction in a form of software. The foregoing processor 1002 may be a general-purpose processor, including a central processing unit (CPU), a network processor (NP), and the like; or may be a digital signal processor (DSP), an application-specific integrated circuit (ASIC), a field programmable gate array (FPGA), or another programmable logic device, a discrete gate or a transistor logic device, or a discrete hardware component. The processor 1002 may implement or perform methods, steps, and logical block diagrams disclosed in the embodiments of the present disclosure. The general purpose processor may be a microprocessor, or the processor may be any normal processor, or the like. The steps of the method disclosed with reference to the embodiments of the present disclosure may be directly performed and completed by a hardware decoding processor, or performed and completed by a combination of hardware and software modules in a decoding processor. The software module may be located in a mature storage medium in the field, such as a random access memory, a flash memory, a read-only memory, a programmable read-only memory, an electrically-erasable programmable memory, or a register. The storage medium is located in the memory 1003. The processor 1002 reads information from the memory 1003, and completes the steps of the foregoing methods in combination with the hardware.

In this embodiment of the present disclosure, the transmission device 1000 indicates, to the second device, the carrier resource used for transmitting the channel state information, so that the second device can send the channel state information of the unlicensed carrier to the transmission device in time, and the transmission device 1000 can make a corresponding scheduling decision in time according to the channel state information of the unlicensed carrier.

Optionally, the carrier indication information is represented by an information bit; or the carrier indication information is represented by a scrambling manner used for transmitting designated signaling; or the carrier indication information is represented by a sequence number of a subcarrier used for transmitting designated signaling.

Optionally, in an embodiment, the processor 1002 is configured to send the carrier indication information to the second device by using the transmitter 1001 and DCI. The DCI carries a CSI request and the carrier indication information, the CSI request is used to request the second device to send the channel state information of the unlicensed carrier, the transmission device 1000 is a base station, and the second device is user equipment.

Further, the carrier indication information is represented by a newly-added bit indicator in the DCI; or the carrier indication information is represented by an unused bit indicator in the DCI; or the carrier indication information is represented by bit information that does not have an indication meaning in the DCI.

Optionally, in another embodiment, the processor 1002 is configured to, when the transmission device 1000 preempts a channel resource in an LBT manner, and the transmission device 1000 does not obtain the channel resource by means of preemption, send the carrier indication information to the second device by using the transmitter 1001. The carrier indication information is used to instruct the second device to transmit the channel state information of the unlicensed carrier on the licensed carrier, the transmission device 1000 is a base station, and the second device is user equipment.

The transmission device 1000 may further execute the method in FIG. 1 and implement functions of the first device or the base station in the embodiments shown in FIG. 1 and FIG. 2. Details are not described herein again in this embodiment of the present disclosure.

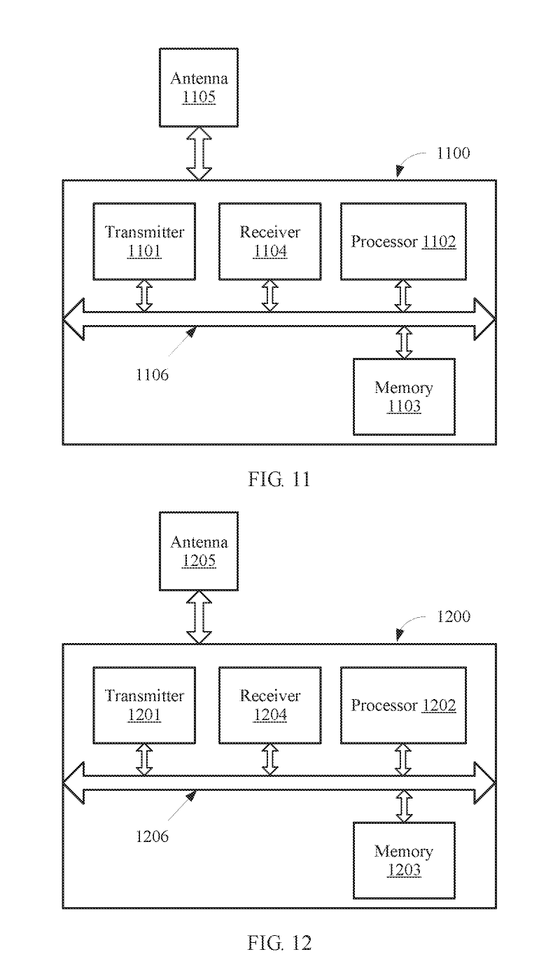

FIG. 11 is a schematic structural diagram of a transmission device 1100 according to an embodiment of the present disclosure. The transmission device 1100 may include a processor 1102, a memory 1103, a transmitter 1101, and a receiver 1104. In specific application, the transmission device 1100 may be a mobile terminal such as a smartphone.

The receiver 1104, the transmitter 1101, the processor 1102, and the memory 1103 are connected to each other by using a bus system 1106. The bus 1106 may be an ISA bus, a PCI bus, an EISA bus, or the like. The bus may include an address bus, a data bus, a control bus, or the like. For ease of indication, in FIG. 11, the bus is indicated by using only one double-headed arrow; however, it does not mean that there is only one bus or only one type of bus. In specific application, the transmitter 1101 and the receiver 1104 may be coupled to an antenna 1105.

The memory 1103 is configured to store a program. The program may include program code, and the program code includes a computer operation instruction. The memory 1103 may include a read-only memory and a random access memory, and provide an instruction and data for the processor 1102. The memory 1103 may include a high-speed RAM memory, and may also include a non-volatile memory, for example at least one magnetic disk memory.

The processor 1102 executes the program stored by the memory 1103 and is configured to perform the following operations: receiving carrier indication information sent by a first device, where the carrier indication information is used to indicate a carrier resource used when the transmission device 1100 sends channel state information of an unlicensed carrier; and when the carrier resource indicated by the carrier indication information is a licensed carrier, sending the channel state information of the unlicensed carrier on the licensed carrier.

The foregoing method that is executed by the second device or the UE and that is disclosed in either of the embodiments in FIG. 2 and FIG. 3 of the present disclosure may be applied to the processor 1102, or may be implemented by the processor 1102. The processor 1102 may be an integrated circuit chip and has a signal processing capability. In an implementation process, steps in the foregoing methods may be completed by means of an integrated logic circuit of hardware in the processor 1102 or an instruction in a form of software. The foregoing processor 1102 may be a general-purpose processor, including a CPU, a NP, and the like; or may be a DSP, an ASIC, a FPGA, or another programmable logic device, a discrete gate or a transistor logic device, or a discrete hardware component. The processor 1102 may implement or perform methods, steps, and logical block diagrams disclosed in the embodiments of the present disclosure. The general purpose processor may be a microprocessor, or the processor may be any normal processor, or the like. The steps of the method disclosed with reference to the embodiments of the present disclosure may be directly performed and completed by a hardware decoding processor, or performed and completed by a combination of hardware and software modules in a decoding processor. The software module may be located in a mature storage medium in the field, such as a random access memory, a flash memory, a read-only memory, a programmable read-only memory, an electrically-erasable programmable memory, or a register. The storage medium is located in the memory 1103. The processor 1102 reads information from the memory 1103, and completes the steps of the foregoing methods in combination with the hardware.

In this embodiment of the present disclosure, the transmission device 1100 reports the channel state information of the unlicensed carrier to the first device in time according to the carrier resource that is used for transmitting the channel state information and that is indicated by the first device, so that the first device can make a corresponding scheduling decision in time according to the channel state information of the unlicensed carrier.

Optionally, the carrier indication information is represented by an information bit; or the carrier indication information is represented by a scrambling manner used for transmitting designated signaling; or the carrier indication information is represented by a sequence number of a subcarrier used for transmitting designated signaling.

Optionally, in an embodiment, the processor 1102 is configured to receive DCI by using the receiver 1104 to obtain the carrier indication information. The DCI carries a channel state information CSI request and the carrier indication information, the CSI request is used to request the transmission device 1100 to send the channel state information of the unlicensed carrier, the first device is a base station, and the transmission device 1100 is user equipment. Further, the processor 1102 is configured to send the channel state information of the unlicensed carrier on the licensed carrier according to the CSI request by using the transmitter 1101.

Further, the carrier indication information is represented by a newly-added bit indicator in the DCI; or the carrier indication information is represented by an unused bit indicator in the DCI; or the carrier indication information is represented by bit information that does not have an indication meaning in the DCI.

Optionally, in another embodiment, the processor 1102 is configured to send the channel state information of the unlicensed carrier on the licensed carrier by using the transmitter 1101 in a first channel state information period after a moment at which the carrier indication information is received by using the receiver 1104.

The transmission device 1100 may further execute the method in FIG. 3 and may implement functions of the second device or the UE in the embodiments shown in FIG. 2 and FIG. 3. Details are not described herein again in this embodiment of the present disclosure.

FIG. 12 is a schematic structural diagram of a transmission device 1200 according to an embodiment of the present disclosure. The transmission device 1200 may include a processor 1202, a memory 1203, a transmitter 1201, and a receiver 1204. In specific application, the transmission device 1200 may be a base station, a relay, a radio AP, or the like.

The receiver 1204, the transmitter 1201, the processor 1202, and the memory 1203 are connected to each other by using a bus system 1206. The bus 1206 may be an ISA bus, a PCI bus, an EISA bus, or the like. The bus may include an address bus, a data bus, a control bus, or the like. For ease of indication, in FIG. 12, the bus is indicated by using only one double-headed arrow; however, it does not mean that there is only one bus or only one type of bus. In specific application, the transmitter 1201 and the receiver 1204 may be coupled to an antenna 1205.

The memory 1203 is configured to store a program. The program may include program code, and the program code includes a computer operation instruction. The memory 1203 may include a read-only memory and a random access memory, and provide an instruction and data for the processor 1202. The memory 1203 may include a high-speed RAM memory, and may also include a non-volatile memory, for example at least one magnetic disk memory.

The processor 1202 executes the program stored by the memory 1203 and is configured to perform the following operations: receiving, on a licensed carrier, channel state information sent by a second device, where the second device does not obtain a carrier resource of an unlicensed carrier at present, the channel state information carries an identifier of the unlicensed carrier, the transmission device 1200 is a base station, and the second device is user equipment; and determining, according to the identifier, that the channel state information is channel state information of the unlicensed carrier.

The foregoing method that is executed by the first device or the base station and that is disclosed in FIG. 4 of the present disclosure may be applied to the processor 1202, or may be implemented by the processor 1202. The processor 1202 may be an integrated circuit chip and has a signal processing capability. In an implementation process, steps in the foregoing methods may be completed by means of an integrated logic circuit of hardware in the processor 1202 or an instruction in a form of software. The foregoing processor 1202 may be a general-purpose processor, including a CPU, a NP, and the like; or may be a DSP, an ASIC, a FPGA, or another programmable logic device, a discrete gate or a transistor logic device, or a discrete hardware component. The processor 1202 may implement or perform methods, steps, and logical block diagrams disclosed in the embodiments of the present disclosure. The general purpose processor may be a microprocessor, or the processor may be any normal processor, or the like. The steps of the method disclosed with reference to the embodiments of the present disclosure may be directly performed and completed by a hardware decoding processor, or performed and completed by a combination of hardware and software modules in a decoding processor. The software module may be located in a mature storage medium in the field, such as a random access memory, a flash memory, a read-only memory, a programmable read-only memory, an electrically-erasable programmable memory, or a register. The storage medium is located in the memory 1203. The processor 1202 reads information from the memory 1203, and completes the steps of the foregoing methods in combination with the hardware.

In this embodiment of the present disclosure, the transmission device 1200 determines, by using the carrier identifier in the channel state information sent by the second device on the licensed carrier, the unlicensed carrier to which the channel state information belongs, so that the transmission device 1200 can make a corresponding scheduling decision in time according to the channel state information of the unlicensed carrier.

The transmission device 1200 may further execute the method in FIG. 4 and may implement functions of the first device or the base station in the embodiment shown in FIG. 4. Details are not described herein again in this embodiment of the present disclosure.

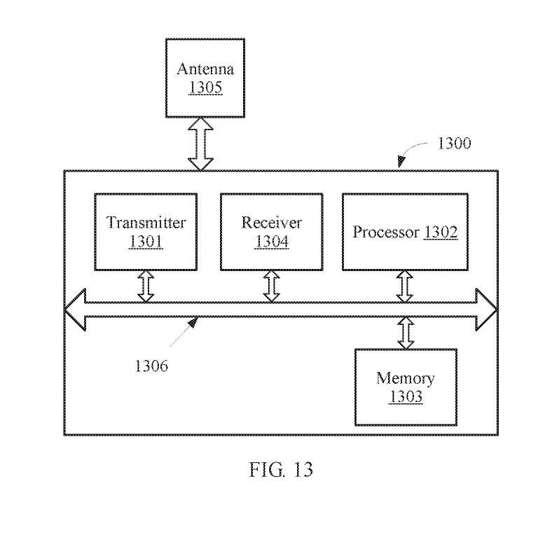

FIG. 13 is a schematic structural diagram of a transmission device 1300 according to an embodiment of the present disclosure. The transmission device 1300 may include a processor 1302, a memory 1303, a transmitter 1301, and a receiver 1304. In specific application, the transmission device 1300 may be a mobile terminal such as a smartphone.

The receiver 1304, the transmitter 1301, the processor 1302, and the memory 1303 are connected to each other by using a bus system 1306. The bus 1306 may be an ISA bus, a PCI bus, an EISA bus, or the like. The bus may include an address bus, a data bus, a control bus, or the like. For ease of indication, in FIG. 13, the bus is indicated by using only one double-headed arrow; however, it does not mean that there is only one bus or only one type of bus. In specific application, the transmitter 1301 and the receiver 1304 may be coupled to an antenna 1305.

The memory 1303 is configured to store a program. The program may include program code, and the program code includes a computer operation instruction. The memory 1303 may include a read-only memory and a random access memory, and provide an instruction and data for the processor 1302. The memory 1303 may include a high-speed RAM memory, and may also include a non-volatile memory, for example at least one magnetic disk memory.

The processor 1302 executes the program stored by the memory 1303 and is configured to perform the following operations: generating channel state information of an unlicensed carrier, where the channel state information carries an identifier of the unlicensed carrier, the transmission device 1300 does not obtain a carrier resource of the unlicensed carrier at present, the first device is a base station, and the transmission device 1300 is user equipment; and sending the channel state information on a licensed carrier.

The foregoing method that is executed by the second device or the UE and that is disclosed in the embodiment in FIG. 5 of the present disclosure may be applied to the processor 1302, or may be implemented by the processor 1302. The processor 1302 may be an integrated circuit chip and has a signal processing capability. In an implementation process, steps in the foregoing methods may be completed by means of an integrated logic circuit of hardware in the processor 1302 or an instruction in a form of software. The foregoing processor 1302 may be a general-purpose processor, including a CPU, a NP, and the like; or may be a DSP, an ASIC, a FPGA, or another programmable logic device, a discrete gate or a transistor logic device, or a discrete hardware component. The processor 1302 may implement or perform methods, steps, and logical block diagrams disclosed in the embodiments of the present disclosure. The general purpose processor may be a microprocessor, or the processor may be any normal processor, or the like. The steps of the method disclosed with reference to the embodiments of the present disclosure may be directly performed and completed by a hardware decoding processor, or performed and completed by a combination of hardware and software modules in a decoding processor. The software module may be located in a mature storage medium in the field, such as a random access memory, a flash memory, a read-only memory, a programmable read-only memory, an electrically-erasable programmable memory, or a register. The storage medium is located in the memory 1303. The processor 1302 reads information from the memory 1303, and completes the steps of the foregoing methods in combination with the hardware.

In this embodiment of the present disclosure, the transmission device 1300 adds the identifier of the unlicensed carrier to the channel state information of the unlicensed carrier, and then sends the channel state information to the first device on the licensed carrier, so that the first device can determine, according to the identifier, the unlicensed carrier to which the channel state information belongs, and the first device can make a corresponding scheduling decision in time according to the channel state information of the unlicensed carrier.

The transmission device 1300 may further execute the method in FIG. 5 and may implement functions of the second device or the UE in the embodiment shown in FIG. 5. Details are not described herein again in this embodiment of the present disclosure.

It should be understood that sequence numbers of the foregoing processes do not mean execution sequences in various embodiments of the present disclosure. The execution sequences of the processes should be determined according to functions and internal logic of the processes, and should not be construed as any limitation on the implementation processes of the embodiments of the present disclosure.

It should be further understood that first, second, and various numerical sequence numbers are for distinguishing only for ease of description, and do not used to limit a scope of the embodiments of the present disclosure.

The term “and/or” in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in some embodiments. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to requirements to achieve the objectives of the solutions of the embodiments.

In addition, functional units in the embodiments of the present disclosure may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present disclosure fully or in part may be implemented in a form of a software product. The software product is stored in a storage medium, and includes several instructions for instructing a computer device (which may be a personal computer, a server, or a network device) to perform all or some of the steps of the methods described in the embodiments of the present disclosure. The foregoing storage medium includes any medium that can store program code, such as a universal serial bus (USB) flash drive, a removable hard disk, a read-only memory (ROM), a RAM, a magnetic disk, or an optical disc.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1-16. (canceled)

17. A method for transmitting channel state information, wherein the method comprises:
sending, by a first device, carrier indication information to a second device, wherein the carrier indication information indicates a carrier resource used when the second device sends channel state information of an unlicensed carrier; and
receiving, by the first device, the channel state information from the second device on a licensed carrier, when the carrier resource indicated by the carrier indication information is the licensed carrier.

18. The method of claim 17, wherein the carrier indication information comprises an information bit.

19. The method of claim 17, wherein the carrier indication information comprises a scrambling manner used for transmitting designated signaling.

20. The method of claim 17, wherein the carrier indication information comprises a sequence number of a subcarrier used for transmitting designated signaling.

21. The method of claim 17, wherein sending the carrier indication information to the second device comprises sending, by the first device, the carrier indication information to the second device using downlink control information (DCI), wherein the DCI comprises a channel state information (CSI) request and the carrier indication information, wherein the CSI request requests the second device to send the channel state information of the unlicensed carrier, wherein the first device is a base station and the second device is user equipment.

22. The method of claim 21, wherein the carrier indication information comprises a newly-added bit indicator in the DCI.

23. The method of claim 21, wherein the carrier indication information comprises an unused bit indicator in the DCI.

24. The method of claim 21, wherein the carrier indication information comprises bit information that does not have an indication meaning in the DCI.

25. The method of claim 21, wherein the channel state information comprises an identifier of the unlicensed carrier, wherein the method further comprises:
determining, by the first device based on the identifier, that the channel state information is channel state information of the unlicensed carrier.

26. A method for transmitting channel state information, wherein the method comprises:
receiving, by a second device, carrier indication information from a first device, wherein the carrier indication information indicates a carrier resource used when the second device sends channel state information of an unlicensed carrier; and
sending, by the second device, the channel state information of the unlicensed carrier on a licensed carrier.

27. The method of claim 26, wherein receiving the carrier indication information from the first device comprises receiving, by the second device, downlink control information (DCI) to obtain the carrier indication information, wherein the DCI comprises a channel state information (CSI) request and the carrier indication information, wherein the CSI request requests the second device to send the channel state information of the unlicensed carrier, wherein the first device is a base station and the second device is user equipment, and wherein sending the channel state information of the unlicensed carrier on the licensed carrier comprises sending, by the second device, the channel state information of the unlicensed carrier on the licensed carrier based on the CSI request.

28. The method of claim 26, wherein the channel state information comprises an identifier of the unlicensed carrier.

29. A transmission device, comprising:
a receiver;
a transmitter;
a memory;
a system bus; and
a processor coupled to the receiver, the transmitter, and the memory via the system bus, wherein the processor is configured to:
send, via the transmitter, carrier indication information to a second device, wherein the carrier indication information indicates a carrier resource used when the second device sends channel state information of an unlicensed carrier; and
receive via the receiver the channel state information from the second device on a licensed carrier, when the carrier resource indicated by the carrier indication information is the licensed carrier.

30. The transmission device of claim 29, wherein the carrier indication information comprises an information bit.

31. The method of claim 29, wherein the carrier indication information comprises a scrambling manner used for transmitting designated signaling.

32. The transmission device of claim 29, wherein the carrier indication information comprises a sequence number of a subcarrier used for transmitting designated signaling.

33. The transmission device of claim 29, wherein the processor is further configured to: send via the transmitter the carrier indication information to the second device using downlink control information (DCI), wherein the DCI comprises a channel state information (CSI) request and the carrier indication information, wherein the CSI request requests the second device to send the channel state information of the unlicensed carrier, and wherein the transmission device is a base station and the second device is user equipment.

34. The transmission device of claim 33, wherein the carrier indication information comprises a newly-added bit indicator in the DCI.

35. The transmission device of claim 33, wherein the carrier indication information comprises an unused bit indicator in the DCI.

36. The transmission device of claim 33, wherein the carrier indication information comprises bit information that does not have an indication meaning in the DCI.
